(19) United States
(12) Patent Application Publication
(10) Pub. No.: US 2012/0196237 A1
(43) Pub. Date: Aug. 2, 2012

(54) Cylindrical burner and method for making the same

(76) Inventors: Clint Murray, Woodstock (CA); Robert Ico, Ancaster (CA); Farshid Ahmady, Rochester Hills, MI (US)

(21) Appl. No.: 12/931,402

(22) Filed: Jan. 31, 2011

(51) Int. Cl. F23D 14/46; C04B 41/53

(52) U.S. Cl. 431/354; 264/629

(57) ABSTRACT

A gas burner for use in water heaters, boilers, cooking appliances or the like uses a ceramic cylindrical body to increase conductivity of the gas burner. The gas burner comprises a solid ceramic perforated tube and a flange arranged on one end of the tube. The burner assembly also compromises a cap arranged on the opposite end of the tube from that of the flange, wherein the tube has turn down characteristics of approximately 30 to 1. The tube is manufactured by molding a non-perforated shell within a die assembly. The non-perforated shell is then dried to a predetermined moisture content and machined with a plurality of orifices into the shell to create the burner tube for a ceramic burner assembly.

### BACKGROUND OF THE INVENTION

1. Field of the Invention

The present invention generally relates to a burner, and more particularly relates to a ceramic cylindrical burner for use in gas burner appliances and other applications.

2. Description of Related Art

Gas burners have been known for many years in the prior art. These gas burners are used in a variety of commercial and residential applications such as kitchen ranges, instant hot water heaters for residential water heating, boilers for residential and space heating, heating oils in deep fryers for commercial applications and the like. These typical gas burner applications have been the focus of global interests because of the recent energy crisis and the envioronmental concerns that have pushed industry toward alternative sources for green technologies. Many different types of material such as ceramics and high temperature alloys have been tested and used as combustion surfaces for gas burners in the prior art. In many cases ceramics provide the ideal thermal properties for gas burner applications, however, they may lack the flexibility for making different geometrical shapes required for some burners such as cylindrical, concave, convex, conical, domed or any other difficult to manufacture shapes. Some of the high temperature alloy metals used in gas burners are more flexible but have high heat conductivity, and are subject to degrading from the extreme temperatures of burners and lack longevity in many of the applications that the commercial and residential users need.

Some of the prior art gas burners are made of stainless steel cylindrical burners, reticulated foam cylindrical burners, composite ceramic/metal fiber cylindrical burners, and molten ceramic fiber burners. However, many of these prior art gas burners are expensive to manufacture, use expensive materials and often require substrates to support the material which adds to the complexity and cost to manufacture such products. Furthermore, many of these prior art gas burners have limitations that reduce there effectiveness and competitiveness in a cost conscience environment. Some of these prior art burners have limited turn down capabilities, while others which are made of reticulated ceramic structure (or ceramic foam), have inconsistence openings resulting in inconsistence burning patter. Furthermore, these burners are fragile and develop hairline cracks over time which results in claps of the burner structure. Furthermore, some of these prior art woven ceramic fiber burners may have a limited turn down capability and seem to be fragile and not as robust as the applications require. Also, many of these prior arts gas burners are not efficient, produce too much pollution and are extremely complicated and expensive to manufacture. Furthermore, many of these prior heating systems require a high level of automation capital costs to produce one unit. These restrictions on the prior art burners do not allow the practical means for manufacturing and impedes the widespread use of these more efficient designs. Therefore, there is a need in the art for a new generation of inexpensive and practical yet reliable and flexible gas burners that can conserve energy and have minimal environmental impact comparing to the prior art gas burners.

Therefore, there is a need in the art for a gas burner that can use both as an atmospheric burner, where combustion air is induced by natural means via a venturi, or as a powered burner wherein the combustion air is provided by a mechanical means such as a blower in the inlet of the burner or an inducer at the outlet of the flue gases. Furthermore, there is a need in the art for utilization of advanced ceramic technology and state of the art manufacturing technologies to produce unique cylindrical or other geometrical shape burners from ceramic materials. Furthermore, there is a need in the art for improved ceramic gas burners because of their excellent thermal properties in combination with the flexibility and fabrication of different geometrical shapes to offer versatile and inexpensive gas burners. Also, there is a need in the art for a free standing gas burner which can be utilized in a variety of commercial and residential gas appliances such as boilers, water heaters, humidifiers, grills, space heaters etc. Furthermore there is a need in the art for a gas burner that has a complex shape and a predetermined wall thickness wherein that wall thickness creates friction that acts on the airflow mixture causing it to create a better turndown ratio i.e., the burners maximum firing capability in relation to the burners minimum firing capability.

### SUMMARY OF THE INVENTION

One object of the present invention may be to provide a gas burner.

Another object of the present invention may be to provide an improved advanced ceramic gas burner in various shapes and material properties.

Another object of the present invention may be to provide a methodology and process for making a ceramic gas burner having an unique cylindrical or other geometrical shape.

Another object of the present invention may be to provide a solid ceramic perforated tube with a flange and cap to act as a cylindrical burner for either a premix powered burner or an atmospheric burner each having turndown characteristics in a range of approximately 30 to 1.

Another object of the present invention may be to provide a ceramic burner that either has a solid cap on one end thereof preformed in the tube or adds the cap, as a separate component, to the top of tube during assembly.

Still another object of the present invention may be to provide a ceramic burner that has a material composition with an extremely low thermal expansion and a high percentage of open porosity to allow for infrared radiant properties at lower BTU input ranges.

Another object of the present invention may be to provide a ceramic burner that has a tube wall thickness determined by the size of a die opening, ranging from approximately a tenth of an inch to nine tenths of an inch.

Still another object of the present invention may be to provide a ceramic burner that has a plurality of holes perforated there through in sizes ranging from one hundredth of an inch to approximately eight hundredths of an inch.

Still another object of the present invention may be to provide for a ceramic gas burner that has a plurality of holes perforated there through with a variety of cross sectional shapes varying from cylindrical, conical, funnel shaped or any other known shape which offers greater modulation and burner performance.

Still another object of the present invention may be to provide a ceramic burner that has any known geometry depending on the application requirements such as but not limited to cylindrical shapes, dome shapes, cone shapes, and any other known shapes.

Yet another object of the present invention maybe to provide a ceramic burner that has a tube cap with an orifice there through to allow for gas to exit from a top of the burner and combust.

Still another object of the present invention maybe to provide for a method of manufacturing a ceramic gas burner that extrudes, injects or casts a ceramic compound into a mold or die form and then machining a plurality of orifices there through in predetermined positions on the burner.

Still a further object of the present invention maybe to provide a method of manufacturing a ceramic gas burner that uses a ceramic compound that is injected, extruded or cast into a mold or die form wherein the mold/die has perforations that allows for a pin bed to be pushed through the tube and die set to form orifices or holes through the surface of the ceramic body of a gas burner.

According to the present invention, the foregoing and other objects and advantages are obtained by a novel design for a gas burner assembly. The gas burner assembly comprises a solid ceramic perforated tube and a flange arranged on one end of the tube. The burner assembly also comprises a cap arranged on an opposite end of the tube, wherein the burner has turndown characteristics of approximately 30 to 1. The ceramic tube for use in the burner assembly is manufactured following a method of extruding, casting or injecting a material into a mold or die mold and then removing that non-perforated shell from the die and machining a plurality of orifices into the shell to allow for usage as a gas burner in either residential or commercial applications.

One advantage of the present invention may be that it provides for an improved gas burner.

A further advantage of the present invention may be that it provides for an improved ceramic gas burner capable of being manufactured into geometrical shapes.

Still a further advantage of the present invention may be that it provides for a ceramic gas burner that can be used as both an atmospheric and a powered gas burner depending on the application and use for the gas burner.

Yet a further advantage of the present invention may be that it provides a solid ceramic perforated tube having a flange and an end cap to act as a cylindrical burner for a burner with turndown characteristics in the range of 30 to 1.

Yet another advantage of the present invention may be that a cap may be arranged on the end of the tube of the burner in a preformed manner or as an extra component to the top of the tube once assembly occurs.

Yet another advantage of the present invention may be that it provides for a gas burner that has a material composition with an extremely low thermal expansion material with a high percentage of open porosity to allow for infrared radiant properties at the lower BTU input ranges.

Yet another advantage of the present invention may be that it provides a ceramic gas burner that has a tube wall thickness determined by the size of the die opening, this thickness may range between 1/10″ to approximately 9/10″ depending on the application.

Another advantage of the present invention maybe that it provides a gas burner that has a plurality of orifices that may range in diameter size from approximately 1/100″ to 9/100″ depending on the combustion gas being used in the appliance.

Another advantage of the present invention may be that it provides for a ceramic gas tube burner with a plurality of orifices there through, wherein the orifices or holes have cross sectional shapes that vary from cylindrical, to conical, to a funnel shape, to any known shape which offers great modulation and burner performance.

Yet another advantage of the present invention maybe that it provides for a gas burner that has a tube cap that can be perforated to allow for gas to exit from the top of the burner and combust.

Still another advantage of the present invention maybe that it provides for a method of manufacturing a ceramic gas burner by using a material mix of ceramic that is either extruded, cast or injected into a die mold then removed from the die mold and machined or drilled with a plurality of holes to allow for the burner to operate in a more efficient manner with a high turndown ratio.

Still another advantage of the present invention may be that it permits a methodology of producing a ceramic gas burner by using a material mix of ceramic and either extruding, casting or injecting it into a die form, wherein that die assembly has perforations to allow for a pin bed to be pushed through the tube and die set to form holes in the ceramic tube being formed therein.

Yet a further advantage of the present invention may be that it provides for a ceramic gas burner that is easy and inexpensive to manufacture and requires less time for assembly thus reducing the cost of the gas burner assembly.

Still another advantage of the present invention may be that it provides for a gas burner that is more robust and lasts longer than prior art burners.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a plan view of a tube burner for use in a gas burner assembly according to the present invention.

FIG. 2 shows a side view of a tube burner for used in the present invention.

FIG. 3 shows a cross sectional view of a tube burner for use in a gas burner assembly according to the present invention.

FIG. 4 shows an end view of a tube burner for use in a gas burner assembly according to the present invention.

FIG. 5 shows a close up of a plurality of perforated holes through a side of a tube burner according to the present invention.

FIG. 6 shows a burner assembly for use with the ceramic tube burner according to the present invention.

FIGS. 7a-7c show various views of a diamond surface pattern for use on a surface of a burner according to the present invention.

FIGS. 8a-8b show various views of a mogul faced pattern for use on a surface of a burner according to the present invention.

FIGS. 9a-9b show various views of a figure eight surface pattern for use on a surface of a burner according to the present invention.

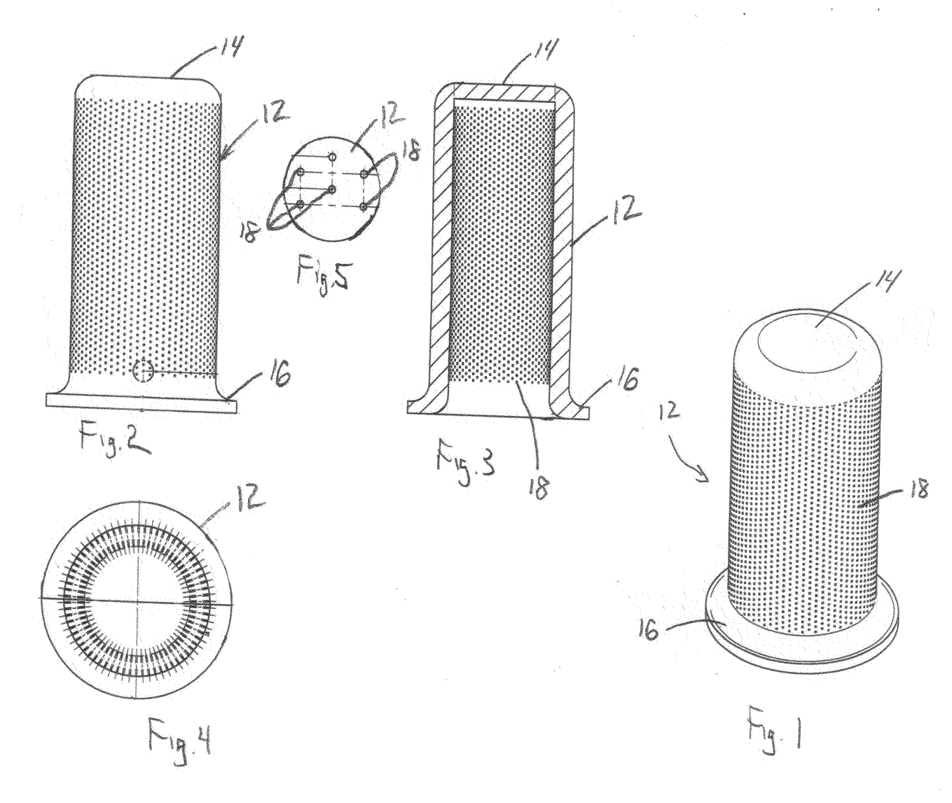

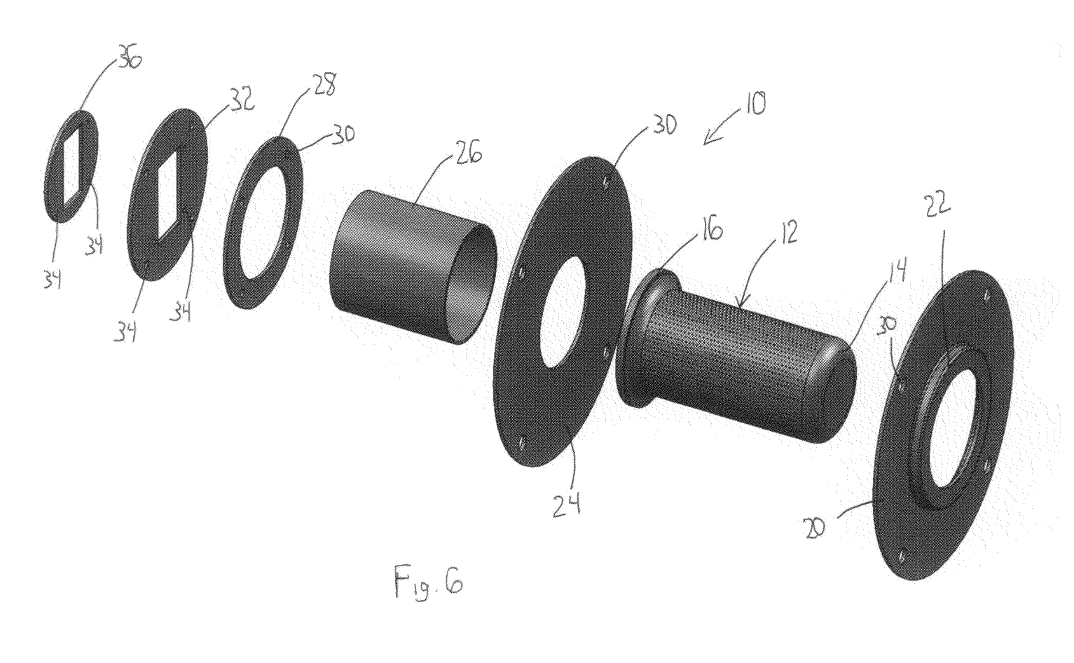

### BRIEF DESCRIPTION OF THE PREFERRED EMBODIMENT(S)

Referring to the drawings, there is shown a ceramic gas burner assembly 10 according to an embodiment of the present invention. The ceramic gas burner assembly 10 is a high efficiency low pollutant apparatus that may create and fill the demand for more efficient and cleaner burners. The ceramic gas burner assembly 10 has a solid ceramic cylindrical burner 12 that is used in gas fired appliances in any known commercial or residential applications. These applications may include but are not limited to kitchen ranges, instant hot water heaters, residential water heating, residential and commercial space heating, heating oils in deep fryers for commercial applications and the like. Generally, the cylindrical burner 12 is comprised of a cap, 14 a flange 16 and perforated cylinder 12 formed into a solid integrated unit. The present invention utilizes advanced ceramic technology and state of the art manufacturing technologies to produce unique cylindrical or other geometrical shaped burners. The excellent thermal properties of ceramics combined with the flexibility of fabrication of different geometrical shapes allows for a versatile and inexpensive, free standing burner for use in the gas industry which can be utilized in a variety of commercial and residential gas appliances such as but not limited to boilers, water heaters, humidifiers, broilers, griddles, fryers, space heaters, and any other known type of gas appliance. Furthermore, it should be noted that the present ceramic gas burner assembly 10 can be used in an atmospheric gas burner, i.e., where combustion is induced by natural means via a venturi into the burner chamber, or be used in a powered gas burner assembly wherein combustion is provided by mechanical means such as a blower in the inlet of the burner or an inducer at the outlet of the flue gas exhaust port. Furthermore, the gas burner 12 according to the present invention due to its complex shape and wall thickness used therein allows for the wall thickness to create friction that acts on the air fuel mixture thereby causing it to create a better turn down ratio for the gas burner assembly 10. The perforated ceramic cylindrical gas burner 12 according to the present invention may be used in boilers, hot water heaters, dishwashers, deep fryers, or any other residential or commercial application that requires a gas burner to create heat.

Generally, the ceramic gas burner assembly 10 of the present invention includes a solid ceramic perforated tube 12 that includes a flange 16 arranged on one end thereof and a cap arranged on the opposite end thereof. The ceramic tube 12 may act as a cylindrical burner in a ceramic gas burner assembly 10 according to the present invention. The cylindrical ceramic burner 12 may be used in either an atmospheric or premixed powered burner, where the burners have a turndown ratio in the range of 30 to 1. As shown in the figures, a flange 16 is formed on one end of the ceramic tube 12. The flange 16 allows for easy assembly to a blower unit. Generally, the flange 16 is arranged at one end and has a predetermined curvature with relation to the main body of the cylinder tube 12. The flange 16 may extend a predetermined distance from the outer surface of the main cylinder tube body 12 this distance is variable depending on the application into which the cylindrical tube burner 12 will be used. Arranged in the opposite end of the tube 12, across from the end that has the flange 16 as shown in the drawings, is arranged a cap 14. The cap 14 is either a solid portion that is formed with the tube 12 to create a single unified tube burner 12 with cap 14 arranged thereon or may be an extra component that is formed on its own in a separate procedure and then secured to the open end on the top of the tube 12 once assembly of the gas burner 12 is begun. Any known methodology for securing the cap 14 when it is a separate piece to the end of the ceramic burner 12 may be used depending on the design and environment in which the burner 10 may be used. The thickness of the cap 14 along with the thickness of the walls of the ceramic tube 12 maybe determined by the size of the die opening. However, in one contemplated embodiment the range for the tube wall thickness is approximately 1/10 of an inch to approximately 9/10 of an inch depending on the application in which the cylindrical burner will be used. It should be noted that the ceramic material that the burner 12 is formed from may have material composition that may allow for a more efficient use of the gas being introduced into the gas burner in any residential and commercial applications.

It should be further noted that an expansion joint may be arranged anywhere along the surface of the cylindrical tube 12 depending on the size of the outer diameter of the tube 12. The expansion joint may be used to overcome thermal stresses that may occur in the ceramic material used to create the cylindrical burner tube 12. The use of the expansion joint may ensure that failure of the ceramic burner tube 12 will most likely not occur thus, increasing efficiency, longevity and durability of the cylindrical tube burner 12 in the application used therein. The tube 12 as shown in the drawings also may include a plurality of orifices or holes 18 through the surface thereof. The tube 12 is perforated with the holes 18 to allow for efficient burning of the fuel mixture in the cylindrical burner 12 thus increasing the efficiency of the appliance being used. These orifices 18 may be used in any known size, however, in one contemplated embodiment the orifices 18 are in the range of approximately 1/100 of an inch to approximately 1/10 of an inch outer diameter depending on the combustion gas being used in the appliance and the environment in which the appliance will be used. It should be noted that the holes 18 may have any known cross sectional shape but in one embodiment cylindrical, conical, or funnel shapes may be used to offer for greater modulation and burner performance characteristics. Hence, it should be noted that the perforated holes 18 generally pass directly through the entire width of the tube 12 in a perpendicular relationship with the outside surface of the tube 12. However, the orifices 18 through the tube may be arranged at an angle to the outside surface of the tube 12 depending on the gas characteristics of the gas being used and the burner efficiency and other environmental factors that the appliance is used therein. These radially aligned or perpendicularly aligned orifices 18 allow for heat transfer throughout the gas burner 12 thus increasing the efficiency and reducing the amount of the gas used in the appliance. It should also be noted the burner geometry may also be varied depending on the application requirement in which the gas burner will be used. Therefore, any known shape such as but not limited to cylindrical, domed, cone shape or the like can be used to fit to specific applications in a commercial or residential application. Also, the tube cap 14 which is arranged on one end of the cylindrical burner 12 may be perforated with at least one or a plurality of orifices to allow for gas to exit from the top of the burner and combust.

One contemplated embodiment of the tube cylinder 12 has an outer diameter of approximately 3.075 inches. It should be noted that the burner 12 may be designed with an outer diameter in the range of ½ inch to approximately 20 inches depending on the design requirements. The outer diameter of the flange 16 may be greater than the outer diameter of the cylindrical body part of the tube 12. The overall length of the gas burner 12 may be in the range of 1 inch to multiple feet depending on the burner 12 and the environment used therein. In one contemplated embodiment a length of approximately 6.75 inches is used in conjunction with an outer diameter of 3.075 inches. In one contemplated embodiment any number of orifices 18 may be arranged through the outer surface of the cylindrical burner 12. In one contemplated embodiment approximately three thousand holes or orifices 18 are arranged in any known pattern through the surface of the cylindrical burner tube 12. It should be noted that the orifices 18 may be arranged in any known pattern depending on the efficiency and the application in which the gas burner 12 will be used. It should be noted that any number of holes 18 from tens of holes to over thousands of holes may be used depending on the size and environment in which the gas burner 12 will be used. It should be noted that ceramic is the preferred material for the gas burner 12 in the present invention however any other material that is capable of operating with the same properties as that of ceramic may also be used for the gas burner 12 according to the present invention.

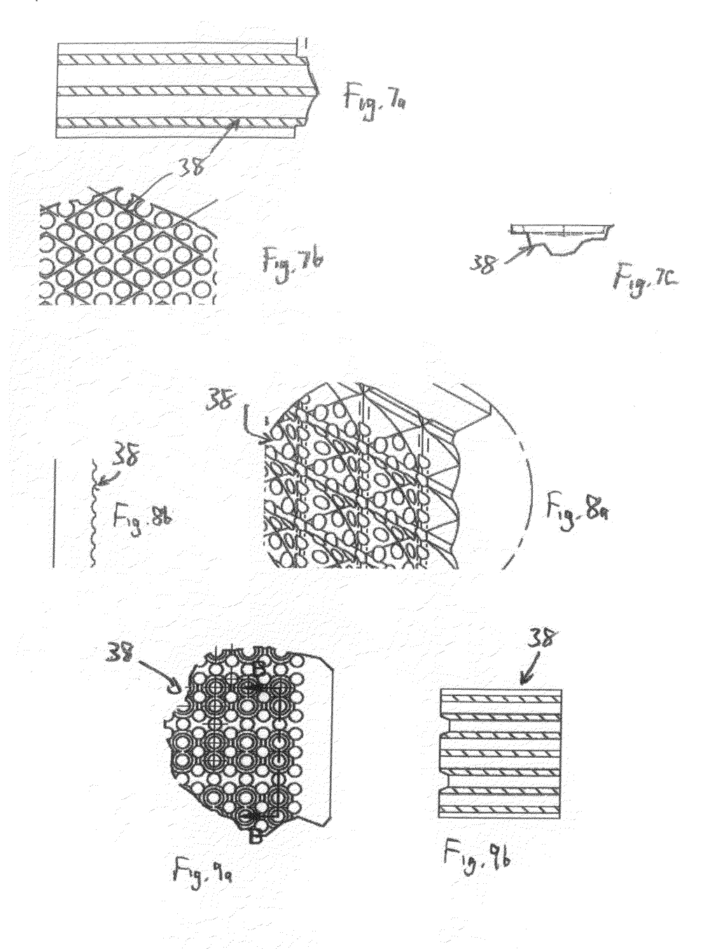

The burner tube 12 may have a surface pattern 38 added to the outside surface of the burner 12 in order to increase the surface area of the overall burner 12 therefore, increasing burner efficiency. It should be noted that the surface pattern 38 may have the form of no pattern at all, a mogul pattern, a diamond pattern, a figured pattern, or any other known shape for outer surface patterns 38 for the outer surface of the burner 12. FIGS. 7a-9b show contemplated embodiments for a diamond surface pattern, a mogul face pattern and a figure eight surface pattern. Any of these patterns 38 may be applied to the outside or inside surface of the burner 12 by either forming or machining and either pre or post sintering thereof. It should be noted that it is also contemplated that the surface patterns 38 are placed on only predetermined portions of the outside surface of the burner 12 or may cover the entire outside surface depending on the design requirements and the use for which the burner 12 may be used. It should be noted that typically the surface pattern 38 is used on burners 12 that typically operate in the infrared heating range. The addition of the surface patterns 38 may increase the burners 12 overall surface area thus increasing the amount of infrared energy being released from the radiating surfaces of the burner 12.

The burner assembly 10 as shown in FIG. 6 also may include a spun mounting flange 20 which is arranged over the tube burner 12 and in contact with one side of the flange 16 of the tube burner 12. The spun mounting flange 20 generally may have a ring like appearance with a flange 22 extending from a middle inner diameter orifice thereof, wherein the flange 22 may engage with the flange 16 of the tube burner 12. Tube burner assembly 10 may also include a first large welded flange 24 which is arranged on the opposite side of the flange 16 of the tube burner 12 and also comes in contact with the spun mounting flange 20 and is secured to the spun mounting flange 20 with any known fastening technique. In one contemplated embodiment a plurality of fasteners are used to connect the larger flange 24 to the spun mounting flange 20. However, it should be noted that any other technique either mechanical or chemical may be used to connect the flanges to one another. A second tube 26 is arranged in contact with the large welded flange 24, either through an orifice through a center of the large welded flange 26 or to a outer surface of the welded flange 26. The second tube 26 may have a predetermined diameter and length. Arranged on an opposite end of the second tube 26 may be a second welded flange or small welded flange 28. This flange 28 may be arranged around either the outer diameter of the second tube 26 or against one end of the second tube 26. The small welded flange 28, the large welded flange 24 and spun mounted flange 22 all include a plurality of orifices 30 there through that are used to connect to either a blower or other portion of the appliance or burner assembly 10 into which it is mounted. Adjacent to the small welding flange 28 may be an adapter plate 32 that generally has a ring like circular appearance with an orifice arranged at a center point thereof. In one contemplated embodiment the orifice may be of a rectangular shape however any other shaped orifice may be used depending on the appliance into which the ceramic gas burner assembly 10 will be arranged. A plurality of orifices 34 are arranged through a surface of the adapter plate 32 and aligned with some of the orifices of the small welded flange 28. The adapter plate 32 may be secured to the welded flange 28 via fasteners or any other fastening technique as described above. The tube burner assembly 10 may also include a blower interface plate 36 that generally has a circular or ring like appearance with an orifice arranged at a mid point thereof. In one contemplated embodiment the orifice is generally of a rectangular shape, however any other shaped orifice may be used depending upon the appliance and component in which the tube burner assembly 10 will be used. The blower interface plate 36 also has a plurality of orifices 34 through a surface thereof and align with and mate with orifices 34 through the adapter plate 32 to allow for the blower interface plate 36 to be secured to the adapter plate 32 with fasteners or any other known fastening technique either mechanical or chemical. The tube burner assembly 10 including all of the flanges and plates may be arranged within an appliance either, in a commercial or residential setting, to allow for the ceramic gas burner 12 to provide the necessary heat via burning of gas or other fuel source. It should be known that this is just one contemplated embodiment of a tube burner assembly 10 and other methods of mounting the tube burner 12 may be used within the appliances or components into which it is being secured.

One contemplated embodiment of the present invention uses a methodology for manufacturing the ceramic tube burner 12 for the tube burner assembly 10 of the present invention by taking a plurality of powdered oxides or non-oxides and mixing those with any known binder or gel casting monomer and initiator and then add water or any other liquid to reach a moisture content of approximately 20-35% for the mixed material. In one contemplated embodiment the powered oxides or non-oxides generally are clay, talc, or organic, these oxides or non-oxides maybe but are not limited to alumina, beryllia, ceria, zirconia, silicon carbide etc. The mixed material has a moisture content of approximately 20-35%, it should be noted that the moisture content maybe in the range of 5% to 50% depending upon the methodology and final product needed. It should be noted that the binders may be but are not limited to any form of chemicals, natural materials, rubbers, metals, plastics, composites, etc. The binders and oxides used in the present invention are all well known and are used in many of the ceramic applications known today. Once the mixed powder or material is mixed to the appropriate formulation and consistency it will then be placed into an extruder vessel or injection vessel and have a vacuum drawn thereon to remove air pockets from the mixed material. After the vacuum is place on the mixed material the mixed material is either extruded, injected or moved into a die mold that incorporates, in one embodiment, a flange 16 and cap 14 into a single tube burner 12. This will create a unified one piece ceramic tube burner 12 for use in the gas burner assembly 10 as described above. However, in another contemplated embodiment the die mold may only incorporate the flange 16 into the mold and the cap 14 may be molded in a separate molding operation and then added and secured later on to one end of the cylindrical body of the tube burner 12. It is also contemplated to just mold the tube burner body 12 in its cylindrical tube shape and mold the flange 16 and cap 14 in separate molding operations and then attach the flange 16 and cap 14 to opposite ends of the cylindrical tube 12 in a separate step. After the mixed material is injected into the die mold and formed into a shell the die assembly will be opened and a non-perforated shell in the form of a tube 12 will be removed. Next, the shell may be placed into a convection dryer which may increase the green strength for secondary processing. The shell may be placed in the convection dryer for a pre-determined amount of time such that the shell is dried to a moisture content of less than approximately 5%. However, it should be noted that the shell may be dried to a moisture of less than 30% or any other number less than 60% depending on the machining to take place thereon thereafter. Once the shell is dried to a moisture level of less than 5% the dry shell is mounted onto a premade and predetermined sized mandrel using a wax support system. The use of the waxed support system may allow for the surface of the dried shell to remain smooth and flaw free, thus increasing the burning characteristics and efficiency of the burner. After the dried shell is arranged and secured on the mandrel it may be mounted into a machine chuck for perforation action thereon. The perforation generally is performed by any type of machine which can drill or machine the desired hole 18 size, geometry, and spacing of the holes 18 into the outer surface of the cylindrical tube 12 of the ceramic burner. In one contemplated embodiment a four axis CNC drilling machine is used to drill these holes 18 through the surface of the burner tube 12. The perforations 18 are performed by a series of gang drilling, which improves the efficiency of the manufacturing process. Once the drilling of all of the orifices 18 through the tube 12 is completed the perforated shell may be sintered in either a gas or electric kiln to a predetermined temperature. In one contemplated embodiment this predetermined temperature is approximately between 1000 degrees Celsius to 2000 degrees Celsius depending on the application. In another embodiment the predetermined temperature range is between 1100 degrees Celsius and 1700 degrees Celsius. Next, post sintering machining of the perforated cylindrical burner 12 may be required to ensure a gas tight seal occurs around the blower face to which the cylindrical burner may be secured. This machining may ensure a flat surface to which the flange of a burner or other flange of the burner assembly may seat and reduce superfluous gas leakage.

A second contemplated embodiment for manufacturing a ceramic gas tube burner in accordance with the present invention will take powered oxides, such as clay, talcs and organics and mix those with binders and add moisture to a content of approximately 20-35%. Next, the mixed power or material may be placed into a vessel, and a vacuum will be applied thereto to remove air pockets from the mixed material. Then, the mixed material may either be extruded, injected or placed into a die form that incorporates a flange and cap assembly. It should also be noted that the flange 16 and cap 14 can be formed and molded into separate components and then added to the tube body 12 of the ceramic tube burner 12 at a later time. It should be noted that in this methodology the die assembly may have perforations arranged therein to allow for a pin bed to be pushed through the tube and die set to form holes or orifices 18 though the tubular body of the ceramic tube burner assembly 10. Once all these orifices 18 have been added to the tube 12 the die will be opened and the perforated tube will be removed. Next, the green tube may be allowed to dry in a convection oven to reduce product moisture to approximately below 3% overall moisture content. It should be noted that moisture content may be 30% or lower depending on the environment in which the burner will be used. Next, after the tube is allowed to dry the completed perforated shell may be sintered in a gas or electric kiln to the specifications described above. Furthermore, if extra sintered machining is required it may then be performed in order to make a gas tight seal around the blower face onto which the gas burner may be used. It should further be noted that other contemplated methodologies of making the ceramic burner 12 may also be used. Therefore, any known methodology to make a ceramic tube 12 can be used as long as the methodology makes the shape of the tube first and then machines or puts the holes into the tube later according to the present invention. The use of the ceramics may allow for increased conductivity of the burned gas through the burner while the price will also be lower and easier to manufacture thus increasing the profit for the sellers of the appliances using the ceramic gas burner according to the present invention.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A method of manufacturing a ceramic burner, said method comprising the steps of:
mixing oxides or non-oxides with a binder to form a mixed material;
transferring said mixed material into a die mold;
removing a non perforated shell from said die;
drying said shell to a predetermined moisture content;
machining a plurality of orifices into said shell; and
sintering said shell to a predetermined temperature.

2. The method of claim 1 wherein said mixed material having a moisture content of approximately 20% to 35%.

3. The method of claim 1 wherein said shell is dried to said moisture of less than 5%.

4. The method of claim 1 wherein said shell is sintered to a temperature range of approximately 1100 C to 1700 C.

5. The method of claim 1 further comprising the steps of placing said mixed material into a vessel and applying a vacuum thereto.

6. The method of claim 1 further comprising the step of injecting or extruding said mixed material into said die.

7. The method of claim 1 further comprising the step of removing said shell from said die.

8. The method of claim 1 wherein said shell is dried in convection dryer.

9. The method of claim 1 further comprising the step of mounting said shell onto a mandrel with a wax support system.

10. The method of claim 9 further comprising the step of mounting said shell and said mandrel into a machine chuck.

11. The method of claim 1 further comprising the step of machining said shell after said sintering to create a gas tight seal.

12. The method of claim 1 wherein said step of machining uses a four axis CNC drilling machine to create a predetermined orifice size, geometry and spacing.

13. The method of claim 1 wherein said die having a plurality of perforations, said perforations receive a pin bed therein.

14. The product produced by the method of claim 1.

15. A burner assembly for use in commercial and residential applications said burner assembly comprising:
a solid ceramic perforated tube;
a flange arranged on one end of said tube;
a cap arranged on another end of said tube; and
said tube having turndown characteristics of approximately 30:1.

16. The burner assembly of claim 15 wherein said flange is formed in said tube.

17. The burner assembly of claim 15 wherein said tube having a wall thickness in a range of approximately 0.15 inch to 0.85 inch.

18. The burner assembly of claim 15 wherein said tube is perforated with a plurality of orifices having a diameter in the range of approximately 0.02 inch to 0.100 inch.

19. The burner assembly of claim 18 wherein said orifices having a cylindrical, conical, or funnel like cross sectional shape.

20. The burner assembly of claim 15 wherein said cap having at least one orifice there through.

21. The burner assembly of claim 15 wherein said tube having an expansion joint.

22. The burner assembly of claim 15 further comprising a spun mounting flange arranged on said tube and in contact with said flange.

23. The burner assembly of claim 22 further comprising a welded flange secured to said spun mounting flange.

24. The burner assembly of claim 23 further comprising a second tube in contact with said welded flange.

25. The burner assembly of claim 24 further comprising a second welded flange arranged over or in contact with said second tube.

26. The burner assembly of claim 25 further comprising an adapter plate secured to said second welded flange and a blower interface plate secured to said adapter plate.
